(19) United States
(12) Patent Application Publication
(10) Pub. No.: US 2018/0137961 A1
(43) Pub. Date: May 17, 2018

(54) MAGNETIC-PHOTOCONDUCTIVE MATERIAL, MAGNETO-OPTICAL DATA STORAGE DEVICE, MAGNETO-OPTICAL DATA STORAGE SYSTEM, AND LIGHT-TUNABLE MICROWAVE COMPONENTS COMPRISING A PHOTOCONDUCTIVE-FERROMAGNETIC DEVICE

(71) Applicant: ECOLE POLYTECHNIQUE FEDERALE DE LAUSANNE (EPFL), Lausanne (CH)

(72) Inventors: Balint NAFRADI, Renens (CH); Endre HORVATH, Lausanne (CH); Laszlo FORRO, Ecublens (CH)

(21) Appl. No.: 15/573,305

(22) PCT Filed: May 12, 2016
(86) PCT No.: PCT/IB2016/052737

§ 371 Date: Nov. 10, 2017

(30) Foreign Application Priority Data
May 12, 2015 (IB) PCT/IB2015/053491

(51) Int. Cl. H01F 10/12; G11B 11/105

(52) U.S. Cl. CPC H01F 10/126; H01P 1/36; G11B 11/10591

(57) ABSTRACT

The present invention concerns a magnetic-photoconductive material including orientable magnetic moments or spins, the material being configured to generate photo-carriers permitting to orientate or re-orientate the magnetic moments or spins at a material temperature less than the Curie Temperature (T_{C}) or Curie point.

### CROSS-REFERENCE TO RELATED APPLICATIONS

The present application claims the priority of international PCT Application PCT/IB2015/053491 that was filed on May 12 2015, the entire contents thereof being herewith incorporated by reference.

### FIELD OF THE INVENTION

The present invention relates generally to magnetizable and photoconducting (PC) material and photoconducting (PC) and ferromagnetic (FM) material, and also to magneto-optical data storage devices and systems as well as tunable microwave components constructed using or including photoconductive (PC) and ferromagnetic (FM) dielectrics.

### DISCUSSION OF THE BACKGROUND ART

Magneto-optical (MO) data storage systems provide storage of data on a disk onto which a magneto-optical recording material has been deposited. The data is stored in the magneto-optical material as spatial variations of the magnetization. During readout, the pattern of magnetization modulates the resistance of a read-head.

In a conventional magneto-optical (MO) storage system, a magnetic coil is placed on a MO head. One component of the magnetic field created by the MO head signifies either a binary one or a binary zero bit value depending on its sign. The magnetization vector is recorded in the magneto-optical material by heat-assisted magnetic writing, usually by focusing a laser beam at a spot on the disk to heat the material above its Curie point or compensation point. This is the temperature at which the magnetization in the material may be readily altered by an applied magnetic field. The magnetic coil of the MO head is then energized to orient the magnetization vector in the material to signify either a binary one or a binary zero bit value. The orientation of the magnetization vector remains after the laser beam is removed and the material cools. After a bit is recorded, it can be erased or overwritten by reheating the same spot above its Curie or compensation point and applying a magnetic field in the opposite direction.

The data recorded on the magneto-optical disk is retrieved usually using the magnetoresistance effect. A disadvantage of current magneto-optical data storage is that the power consumption required for the heat assisted writing of the MO medium is high. The heat load during writing is substantial. It limits (re)write speed and the available materials which must sustain many rewrite cycles without performance loss. Also a relatively high-power and thus expensive laser is required.

Accordingly, there is a need for an improved magneto-optical recording media that does not require such or any temperature change, or does not require high light-powers and lasers. The present invention fulfills this need.

Moreover, typical microwave components are designed by establishing specific values of the characteristic impedance, Z, and the electrical length (at an operating frequency F. In frequency tunable microwave components maintaining specific Z, p independent of F is required so that a circuit or system can operate within particular design parameters Z and (independent of the operation frequency.

As it is well known by one of ordinary skill in the art, the electrical length of a transmission line is equal to ϕ=2πFL\sqrt{με}, where F is the operating frequency, L is the physical length of the transmission line, and \sqrt{με} is the microwave velocity through a medium having an electric permittivity (ε) and a magnetic permeability (μ). As is also well known to those of ordinary skill in the art, the characteristic impedance, Z, of a transmission line equals Z=G\sqrt{μ/ε}, where G represents a constant characteristic to the device geometry. Based on the aforementioned equations, it is straight forward to see that if a device is tuned to have Z₁ and φ₁ at frequency F₁ and operation at frequency F₂=a*F₁ required with Z₁=Z₂ and φ₁=φ₂ then the magnetic permeability (μ) and dielectric permittivity (ε) should be varied such that at F₂=a*F₁ frequency μ₂=1/a*μ₁ and ε₂=1/a*ε₁.

As it is also well known to those of ordinary skill in the art, ferromagnetic materials commonly referred to as “ferrites” are broadly used in various microwave components and systems like in microwave isolators, phase shifters attenuators and alike. In all these devices the operation frequency is determined by F=γ/2π\sqrt{B*(B+μM)} ferromagnetic resonance frequency of the ferroamagnetic component, where B is a biasing external field, γ is a gyromagnetic ratio μ is the magnetic permeability and M is the magnetization. Common tuned “ferrite” microwave components utilize tunable biasing field B or change of the temperature of the ferromagnetic component.

All the aforementioned frequency tunable microwave components, however, require switching of high currents, high voltages or both. This method has relative high power consumption and low operation speed. It also makes the frequency tunable microwave devices expensive.

The present invention addresses the above mentioned problems.

### SUMMARY

The present disclosure thus concerns a magnetic-photoconductive material according to claim 1 or 24, a magneto-optical data storage device according to claim 2, a magneto-optical system according to claim 3, a method for operating the magneto-optical system according to claim 6, a tunable microwave component according to claim 9, a method for operating the tunable microwave component according to claim 16, a magneto-optical storage device according to claim 17, a tunable microwave component according to claim 19, and a method for writing information to magneto-optical material according to claim 22.

Other advantageous features can be found in the dependent claims.

A magneto-optical (MO) data storage device or system incorporates a material or dielectric having both photoconductive (PC) and ferromagnetic (FM) properties as magneto-optical recording material.

The magnetization of the material can be varied with externally applied light and magnetic fields without temperature change of the magneto-optical recording material such that the digital information is encoded by the spatial change of the magnetization.

A frequency tunable microwave component or device incorporates a material or dielectric having both photoconductive (PC) and ferromagnetic (FM) properties. These properties can be varied with externally applied light and magnetic fields such that the component can be tuned by light-illumination. The microwave component can be used, for example, in microwave devices such as phase shifters, frequency filters, directional couplers, power dividers and combiners, impedance-matching networks, tunable attenuators, microwave cavities, isolators and other microwave devices where ferromagnetic materials are used as active component.

To construct tunable microwave devices addressing the above-mentioned disadvantages of current microwave devices, the present invention includes and utilizes photoconductive (PC) ferromagnetic (FM) materials in the construction of the devices. The present invention exploits the PC and FM material properties to controllably vary the magnetic permeability (μ) and dielectric permittivity (ε) by light illumination to maintain constant characteristic impedance and electrical length regardless of the frequency at which the device is tuned and to set the ferromagnetic resonance frequency to a desired value by light illumination.

Because PC and FM materials possess the advantage of high switching speeds, and low power consumption, microwave devices according to the present invention provide for higher speed lower operation cost microwave systems.

The above and other objects, features and advantages of the present invention and the manner of realizing them will become more apparent, and the invention itself will best be understood from a study of the following description with reference to the attached drawings showing some preferred embodiments of the invention.

### A BRIEF DESCRIPTION OF THE DRAWINGS

The above object, features and other advantages of the present invention will be best understood from the following detailed description in conjunction with the accompanying drawings, in which:

FIG. 1(a) shows a schematic representation of a magnetic and photoconductive material or composition according to an aspect of the present invention;

FIGS. 1(b) to 1(d) show a schematic representation of a magnetic and photoconductive layered structure according to another aspect of the present invention;

FIG. 2 shows an exemplary magneto-optical system according to an aspect of the present invention;

FIG. 3 shows an exemplary stripline microwave transmission line according to another aspect of the present invention;

FIG. 4 shows an exemplary microwave isolator according to yet another aspect of the present invention;

FIG. 5 shows an exemplary microwave attenuator or phase shifter according to another aspect of the present invention;

FIGS. 6(a) to (c) show a sample and measurement configuration, where FIG. 6(a) is a photo of a typical CH₃NH₃(Mn:Pb)I₃ crystal, 10-15 of them were assembled for the ESR measurement; FIG. 6(b) is a sketch of the crystal structure of CH₃NH₃(Mn:Pb)I₃; and FIG. 6(c) shows an experimental configuration for high-field ESR measurements, the absorption of the microwave field (up to 157 GHz) is monitored in resonant conditions in dark and under illumination, the light source is a red (λ=655 nm, 4 μW/cm²) Light Emitting Diode (LED) activated by an external switch;

FIGS. 7(a) to (d) show the illumination effect on the magnetic properties of CH₃NH₃(Mn:Pb)I₃ measured by ESR, where FIG. 7(a) shows ESR linewidth and resonant field (offset by a reference value B₀) as a function of temperature recorded at 9.4 GHz, their temperature independent behaviour is characteristic for the paramagnetic phase (PM), the upturn below 25 K corresponds to the on-set of the FM phase; FIG. 7(b) shows a 157 GHz and 5 K spectra of pristine CH₃NH₃PbI₃, of CH₃NH₃(Mn:Pb)I₃ in dark coming from the FM phase, and its reduction upon visible light illumination, the difference between light-off and light-on signal is also shown; FIG. 7(c) shows a light-on ESR linewidth normalized to the linewidth in dark, the narrowing of the linewidth upon illumination starts below T_{C}, the inset gives the raw AB for light-off and light-on versus temperature and resonant field—the two curves depart only below T_{C}; FIG. 6(d) shows the difference of the ESR intensities between the light-off and light-on cases as a function of temperature, the intensity reduction upon illumination is present only below 25 K, in the FM phase;

FIGS. 8(a) to (c) show First-principles calculations of the atomic configurations and magnetic order of CH₃NH₃(Mn:Pb)I₃, where FIG. 8(a) shows a total density of states (DOS) and projected density of states (PDOS) calculated for the “in-plane” model of CH₃NH₃(Mn:Pb)I₃ in its neutral FM configuration; FIG. 8(b) shows the calculated Pb—I and Mn—I distances for a single Mn dopant; and FIG. 8(c) shows calculated bond angles and bond distances for the I mediated superexchange paths in the FM ground state of the “in-plane” model of CH₃NH₃(Mn:Pb)I₃;

FIG. 9 is a schematic illustration of writing a magnetic bit, where in the dark (left side) the spin alignment corresponds to a given orientation of the magnetic moment in the FM state, representing a bit; upon illumination (central part) the FM order melts and a small magnetic field of the writing head will set the orientation of the magnetic moment once the light is switched off (right side);

FIGS. 10(a) and (b) shows Synchrotron powder X-ray diffraction data, where FIG. 10(a) shows a room temperature synchrotron powder X-ray profile of CH₃NH₃Mn:PbI₃ (wavelength of the synchrotron radiation is equal to 0.9538 Å), stars and solid and thin lines correspond to experimental data and calculation, respectively, strips indicate positions of the Bragg reflections, the Rietveld refinement shows a perfectly single phased material: CH₃NH₃Mn:PbI₃ sample is free of Pb₂, Mn clusters or any other impurity; and FIG. 10(b) shows structural characteristics and details of the refinement of CH₃NH₃Mn:PbI₃ at 293 K;

FIGS. 11(a) to (d) show SEM micrographs and Energy dispersive X-ray spectroscopy results, where FIG. 11(a) shows a SEM micrograph of a typical CH₃NH₃Mn:PbI₃ single crystal of several mm in length and 100×100 m² in cross-section; FIG. 11(b) is a zoom on a broken section of the needle shown in FIG. 11(a); FIGS. 11(c) and (d) are an EDS sum spectrum obtained at the as grown and broken surfaces indicated by ×C and ×D, respectively in FIG. 11(b); The stoichiometry at both regions is Pb_{0.9}Mn_{0.1}I₃, testifying the homogeneous bulk substitution of Mn ions;

FIG. 12 show photocurrent spectra and more particularly photocurrent of CH₃NH₃Mn:PbI₃ and CH₃NH₃PbI₃ at fixed bias voltage of 1 V measured as a function of photon energy at 300 K, the strong photocurrent generation above the optical band gap of ˜830 nm of CH₃NH₃Mn:PbI₃ is red shifted by about 46 nm relative to that of the pristine CH₃NH₃PbI₃ material (783 nm), lines are fits to modelling the band edge by the Fermi-Dirac distribution and its thermal broadening;

FIGS. 13(a) and (b) show the basic principle of ESR signal detection, where FIG. 13(a) shows conventional magnetic field modulation used in 9.4 GHz ESR experiments, the Upper curve represents the ESR absorption A as a function of magnetic field B, the modulation magnetic field B×cos(ωt) and the resulting modulated microwave absorption power dA/dB×cos(ωt) are also illustrated, the lower panel depicts the first derivative dA/dB signal of the ESR absorption line A after lock-in detection; FIG. 13(b) shows a microwave (MW) chopping detection used for 105 and 157 GHz ESR experiments, the microwave radiation is periodically switched on/off, accordingly, the ESR absorption signal is modulated as shown, the lower panel presents the resulting absorption ESR line A after lock-in detection;

FIGS. 14(a) to (c) show room temperature 9.4 GHz ESR spectra, where FIG. 9(a) shows a Spectrum of pristine CH₃NH₃PbI₃, only a weak paramagnetic impurity signal is observed characteristic of ppm level defect concentration; FIG. 14(b) shows a Spectra of CH₃NH₃Mn:PbI₃ with low (˜1%) Mn concentration, a forbidden hyperfine signal (middle) and allowed hyperfine sextet line (bottom) of the Mn²⁺ reproduce the observed signal well (top), the well-resolved hyperfine structure indicates the homogeneous dispersion of the Mn²⁺ ions; FIG. 14(c) shows a Spectrum of CH₃NH₃Mn:PbI₃ with high (10%) Mn concentration;

FIGS. 15(a) and (b) show multifrequency ESR properties of CH₃NH₃Mn:PbI₃, where ESR at 105 and 157 GHz frequencies were measured as a function of temperature and are shown in FIGS. 15(a) and (b) respectively; the temperature dependence of the linewidth scales with the temperature dependence of the ESR shift B₀(ref)−B₀ showing that both quantities measure the local dipole field distribution of the polycrystalline ferromagnetic material;

FIG. 16 shows models of the Pb and Mn distributions in CH₃NH₃Mn:PbI₃ studied by means of first-principles calculations, where schematic drawings of three models of CH₃NH₃Mn:PbI₃ containing pairs of Mn dopants in close proximity to each other in the 2×1×2 supercell are illustrated; the three configurations investigated are referred to as “top”, “in-plane”, and “diagonal”; for clarity reasons, only Pb (dark) or Mn (light) atoms are shown and the unit cell of the undoped orthorhombic-phase CH₃NH₃PbI₃ is indicated by black lines;

FIG. 17 shows density of states plots for the electron- and hole-doped models of CH₃NH₃Mn:PbI₃; total and projected density of states plots are calculated from first principles for the hole- and electron-doped “in-plane” model of CH₃NH₃Mn:PbI₃ in the AFM ground state;

FIG. 18(a) shows an Electron Spin Resonance spectra demonstrating the formation of photoconductive magnetic materials for a photoconduction magnetic material (LaSr)MnO₃ CH₃NH₃PbI₃ and more particularly (La_{0.7}Sr_{0.3})MnO₃:CH₃NH₃PbI₃; and

FIG. 18(b) shows an Electron Spin Resonance spectra demonstrating the formation of photoconductive magnetic materials for a photoconduction magnetic material CH₃NH₃(Pb:Gd)I₃.

### DETAILED DESCRIPTION OF SEVERAL EMBODIMENTS

The present invention will now be described more fully hereinafter with reference to the accompanying drawings, in which representative embodiments of the invention are shown. This invention may, however, be embodied in many different forms and should not be construed as limited to the embodiment set forth herein; rather, these embodiments are provided so that this disclosure will be thorough and complete, and will fully convey the scope of the invention to those skilled in the art.

Like numbers refer to like elements throughout.

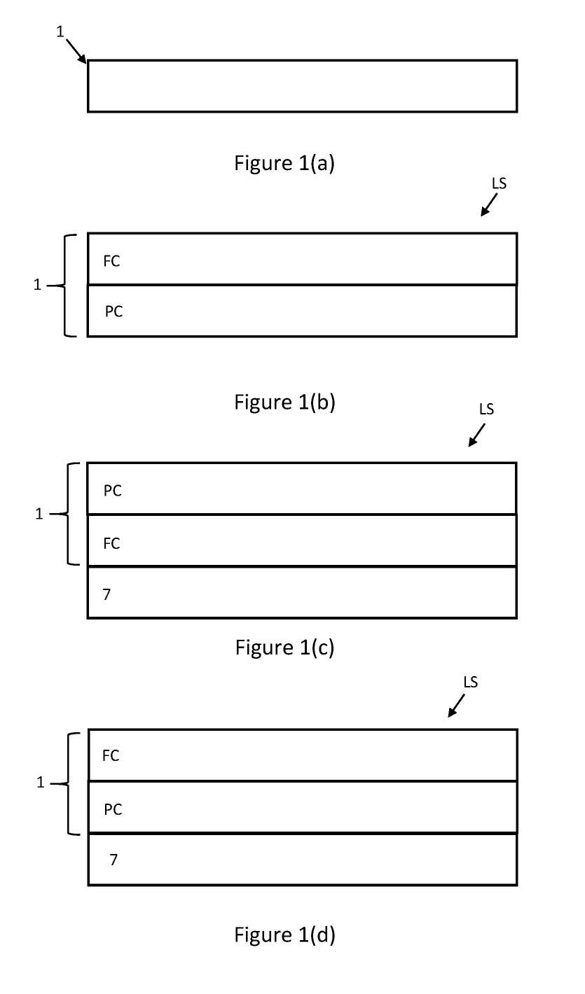

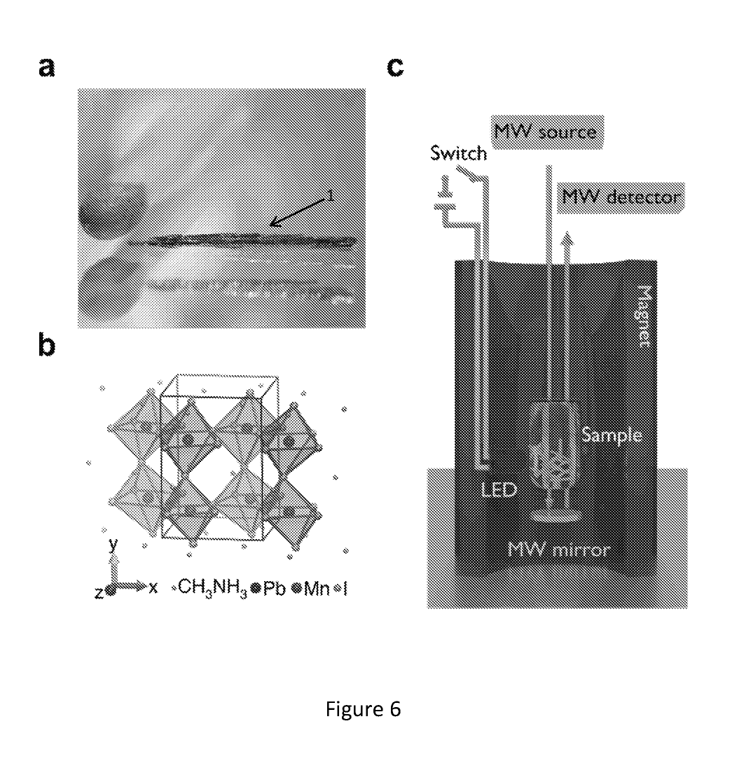

One aspect of the present invention concerns a (ferro)magnetic and photoconductive material or composition 1 as schematically shown, for example, in FIG. 1(a) and shown for example in FIG. 6 (a).

The magnetic and photoconductive material 1 comprises magnetic properties and more particularly magnetic spins or moments whose direction can be changed and aligned to register information in the material 1. Additionally, the magnetic and photoconductive material 1 is configured to generate photocarriers when illuminated. The generated photocarriers interact with the magnetic spins or moments to put the magnetic spins or moments in a state that permits the orientation or re-orientation of the magnetic spins or moments without increasing the temperature of the material 1 above the Curie temperature or Curie point of the material. That is, the generated photocarriers interact with the magnetic spins or moments to put the magnetic spins or moments in a state that permits a temperature-change free orientation or re-orientation of the magnetic spins or moments.

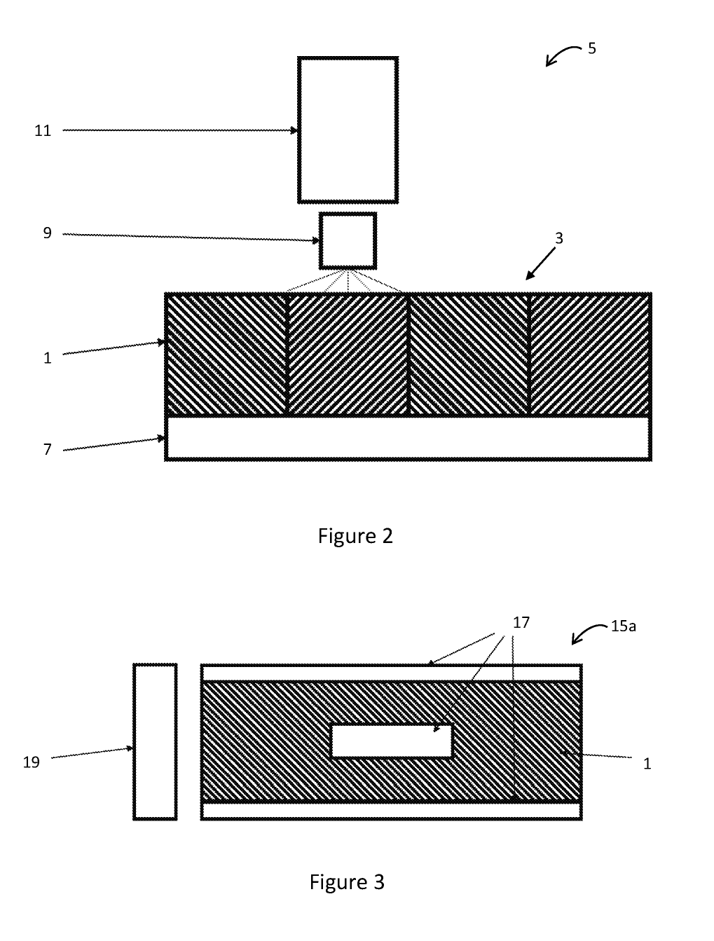

The magnetic-photoconductive material or composition 1 can be included in a magneto-optical storage device (or plate/unit) 3 as shown, for example, in FIG. 2. The magneto-optical storage device 3 can be included in a magneto-optical information storage apparatus or system 5 in which information is stored in the magnetic-photoconductive material 1 of magneto-optical storage device 3.

When an area or volume of the magnetic-photoconductive material 1 is illuminated by a low-power light beam (for example 1 nWcm⁻² to 200 nWcm⁻²), conduction electrons are generated therein by the incident light. The generated electrons can permit a magnetic order located in the illuminated zone or volume of the magnetic-photoconductive material 1 to be removed. The generated electrons change a state of the magnetic-photoconductive material 1 from a first state where the recording of a magnetization direction does not occur when an external magnetic field is applied to a second state where the recording of a magnetization direction occurs when an external magnetic field is applied to the illuminated area or volume of the magnetic-photoconductive material 1.

The magnetic order is melted, that is, put in a state to be configured or reconfigured without changing the temperature of the magnetic-photoconductive material 1. During the registration of a magnetization direction, the applied optical power to the magnetic-photoconductive material 1 generates no temperature change in the magnetic-photoconductive material 1. The only possible temperature change that occurs in storage plate or unit 1 may be due to a fluctuation in the ambient temperature. The application of the optical energy permits a temperature-change free change of state from the above mentioned first to second state, and a temperature-change free registration or recording of a magnetization direction.

The magnetic-photoconductive material 1 permits the above mentioned state change or the registration or recording of a magnetization direction in the material 1 at a material temperature less than the Curie Temperature (T_{C}) or Curie point. The incident optical power on an area or volume of the magnetic-photoconductive material 1 does not increase the material temperature above the Curie Temperature (T_{C}) or Curie point.

Once the conduction electrons are generated, an external magnetic field is simultaneously applied to the area or volume of the material 1 to encode information via a magnetization direction written into the material 1 by the applied magnetic field. The incident light is switched off and the photocarriers are removed and disappear.

Accordingly the magnetization of the material 1 is recovered with a direction parallel to the write-field. The achievable switching time of the material 1 is in the 1 to 10 ns range required for relaxation of photo-excitations.

The magnetic and photoconductive material 1 also permits to controllably vary the magnetic permeability (μ) and dielectric permittivity (ε) by light illumination and the generation of photo-carriers. The achievable switching time is equally in the 1 to 10 ns range limited by the relaxation of photo-excitations.

The material or composition 1 is thus a magnetizable and photoconducting composition.

The magnetic and photoconductive material or composition 1 comprises or consists of, for example, a magnetic and photoconductive perovskite (or a magnetic photovoltaic perovskite).

According to one aspect of the present invention, the magnetic-photoconductive composition 1 includes or consists of a perovskite structure having the general formula ABC₃, where A is a cation selected from any one element or any combination of elements of the following group: Li, Na, K, Rb, Cs, NH₄, NCL₄, PH₄, PF₄, AsH₃, CH₃PH₃, CH₃AsH₃, CH₃SbH₃, and CH₃NH₃.

B of the formula ABC₃ is a cation selected from any one divalent element or any combination of divalent elements of the following divalent element group: Mn, Co, Cr, Fe, Cu, Ni, and rare earths.

The rare earth elements include Ce, Pr, Nd, Pm, Sm, Eu, Gd, Tb, Dy, Ho, Er, Tm, Yb, Lu, Sc, Y, Ac and La.

Alternatively, B of the formula ABC₃ can be a cationic composition of the general formula DₓE_{y}F_{z}, where D==Pb²⁺, F=Sn²⁺ and E is selected to be any one divalent element or any combination of the following divalent elements of the group: Mn, Co. Cr, Fe, Cu, Ni, and rare earths. x, y and z of the general formula DₓE_{y}F_{z} are a weight percent and preferably y≥0.08, 0≤x≤0.92 and 0≤z≤0.92 where x+y+z==1. That is, B comprises substantially at least 8% weight percent of the selected following divalent element or elements: Mn, Co, Cr, Fe, Cu, Ni, and divalent rare earths.

C of the formula ABC₃ is an anion and can be any one halogen or any combination of halogens. For example, any one or any combination of the following halogens: F, Cl, Br, I, At.

The magnetic and photoconductive material or composition 1 can be for instance CH₃NH₃(Gd:Pb)I₃ and more particularly, for example, CH₃NH₃(Gd_{0.8}:Pb_{0.92})I₃(the rare earth Gd is present at weight percent of 0.8% and Pb at 92%).

CH₃NH₃(Gd:Pb)I₃ single crystals can be prepared by precipitation from a concentrated aqueous solution of hydriodic acid (57 w % in H2O, 99.99% Sigma-Aldrich) containing lead (II) acetate trihydrate (99.999%, Acros Organics), Gadolinium (III) acetate tetrahydrate (99.0%, Fluka) and a respective amount of CH₃NH₂ solution (40 w % in H2O, Sigma-Aldrich).

To apply or deposit the crystals to a substrate, the CH₃NH₃(Pb:Gd)I₃ crystals are simply precipitated from the solution covering the substrate.

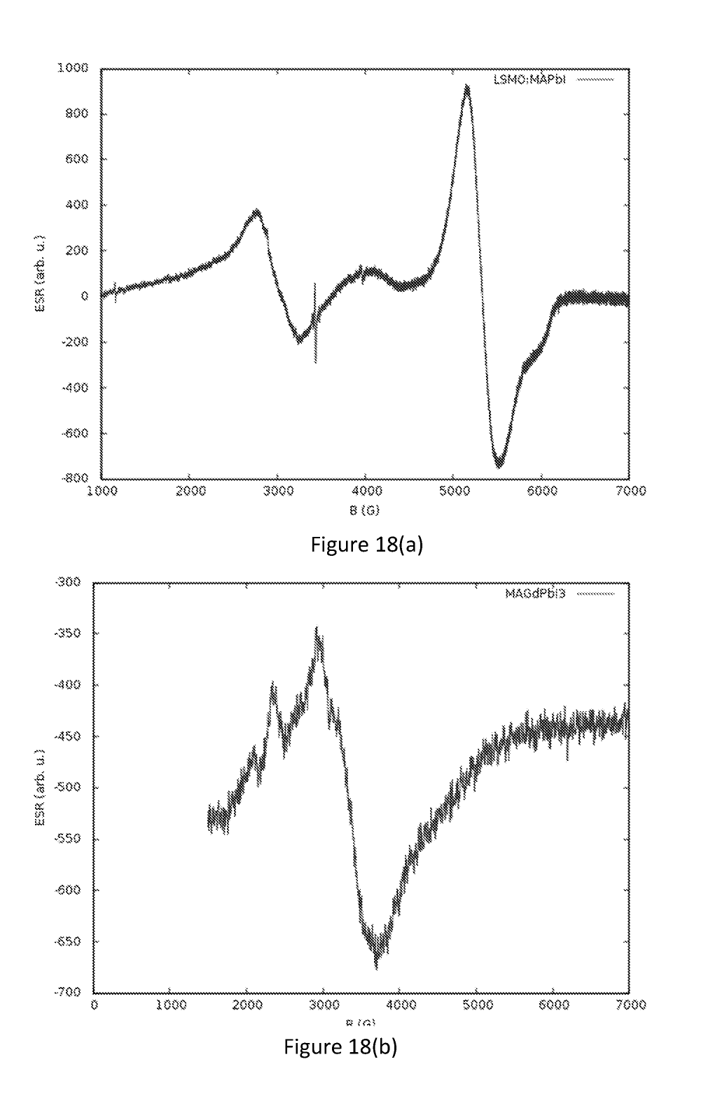

FIG. 18(b) shows an Electron Spin Resonance spectra demonstrating the formation of photoconductive magnetic materials for a photoconduction magnetic material CH₃NH₃(Pb:Gd)I₃.

The magnetic and photoconductive material or composition 1 can alternatively be for instance CH₃NH₃(Pb:Mn:Sn)I₃ and more particularly, for example, CH₃NH₃(Pb_{0.5}:Mno_{0.2}:Sno_{0.3})I₃ (the element Mn is present at weight percent of 20%, Sn at 30% and Pb at 50%). The cationic composition thus comprises 20% weight percent of Mn.

CH₃NH₃(Pb:Mn:Sn)I₃ single crystals can be prepared by precipitation from a concentrated aqueous solution of hydriodic acid (57 w % in H2O, 99.99% Sigma-Aldrich) containing lead (II) acetate trihydrate (99.999%, Acros Organics), manganese (II) acetate tetrahydrate (99.0%, Fluka) tin (II) acerate (99% Sigma-Aldrich) and a respective amount of CH₃NH₂ solution (40 w % in H2O, Sigma-Aldrich).

To apply or deposit the crystals to a substrate, the crystals are also simply precipitated from the solution covering the substrate.

For example, The magnetic and photoconductive material or composition 1 can be CH₃NH₃(Mn:Pb)I₃ for example CH₃NH₃(Mn_{0.1}:Pb_{0.9})I₃ (that is, the element Mn is present at weight percent of 10% and Pb at 90%). Preparation of this material is described below.

According to another aspect of the present invention, the magnetic-photoconductive material or structure 1 includes or consists of a layered structure LS including at least one photoconductive (PC) layer and at least one magnetic layer (FC) as shown, for example, in FIGS. 1(b) to 1(d).

The photoconductive layer PC includes or consists of a perovskite structure of the general formula ABC₃, where A is a cation selected to be any one element or any combination of the following elements of the group: Li, Na, K, Rb, Cs, NH₄, NCl₄, PH₄, PF₄, AsH₃, CH₃PH₃, CH₃AsH₃, CH₃SbH₃, and CH₃NH₃.

B of the formula ABC₃ is a cation selected to be any one divalent element or any combination of the following divalent elements of the group: Pb, Sn, Mn, Co, Cr, Fe, Cu, Ni and rare earths.

C of the formula ABC₃ is an anion selected to be any one halogen or any combination of halogens, for example, of the following halogens: F, Cl, Br, I, At.

For example, the photoconductive PC layer may be CH₃NH₃PbI₃.

CH₃NH₃PbI₃ single crystals can be prepared by precipitation from a concentrated aqueous solution of hydriodic acid (57 w % in H2O, 99.99% Sigma-Aldrich) containing lead (II) acetate trihydrate (99.999%, Acros Organics) and a respective amount of CH₃NH₂ solution (40 w % in H2O, Sigma-Aldrich).

The magnetic or ferromagnetic layer FC includes or consists of a perovskite structure of the general formula ABC₃ where A is a cation and can be any one rare earth element or any combination of rare earth elements. Alternatively, A of the general formula ABC₃ is a cation selected to be any one rare earth element or any combination of rare earth elements combined with any Periodic table Group II element or elements. A of the general formula ABC₃ can also be a cation selected to be any one rare earth element or any combination of rare earth elements combined with any Periodic table Group III element or elements.

As previously mentioned, the rare earth elements include Ce, Pr, Nd, Pm, Sm, Eu, Gd, Tb, Dy, Ho, Er, Tm, Yb, Lu, Sc, Y, Ac and La. Group II elements include Be, Mg, Ca, Sr, Ba, Ra. Group III elements include Sc, Y, Lu and Lr.

B of the general formula ABC₃ is a cation selected from any one divalent element or any combination of divalent elements of the group: Mn, Ni, Cr, Fe. C of the general formula ABC₃ is an anion that is oxygen.

For example, the magnetic or ferromagnetic FC layer may be (La: Ca)MnO₃ or (La: Sr)MnO₃.

The weight percent of La:Ca or La:Sr is for example 70%:30% ((La_{0.7}:Ca_{0.3})MnO₃ or (La_{0.7}:Sr_{0.3})MnO₃). This value can however be largely varied in the range Gₓ:H_{y}, where G, H is A in the formula ABC₃ and is, in the above example, G=La and H=Ca or Sr and 0≤x≤0.0 and 0≤y≤1.0 where x+y=1. Where A consists of three elements for example Gₓ:H_{y}:J_{z} then 0≤x≤1.0, 0≤y≤1.0 and 0≤z≤1.0 where x+y+z=1.

The layered structure LS also has the above mentioned properties and advantages described in relation to the magnetic-photoconductive material 1, schematically shown in FIG. 1(a).

The layered structure LS may include or consist of one photoconductive PC layer and one magnetic FC layer. Alternatively, the layered structure LS may include or consist of a plurality of photoconductive PC and magnetic FC layers. For example, a plurality of magnetic FC layers separated by one photoconductive PC layer.

The layer structure LS may include a substrate 7. The substrate 7 can be, for example, a (100) SrTiO₃ single crystal substrate, a Si substrate, a glass substrate or a plastic (transparent) substrate. The substrate may alternatively be a substrate comprising or consisting of the PC layer, for example, CH₃NH₃PbI₃ as shown in FIG. 1(b).

For example, an FC layer of (La: Sr)MnO₃ epitaxial thin films can be grown on a (100) SrTiO₃ single crystal substrate using magnetron sputtering, in 0.06 mbar flowing Argon pressure. The substrate is maintained at room temperature during sputtering and is then annealed after film growth in flowing Oxygen at 800 C for an hour.

Alternatively, for example, an FC layer of (La:Ca)MnO₃ epitaxial thin films can be grown on (100) SrTiO₃ single crystal substrate using magnetron sputtering, in 0.06 mbar flowing Argon pressure. The substrate is maintained at room temperature during sputtering and is then annealed after film growth in flowing Oxygen at 800 C for an hour.

A PC layer of, for example, a CH₃NH₃PbI₃ coating on the (La:Sr)MnO₃ or (La:Ca)MnO₃ film can be made by evaporating a droplet of saturated solution of CH₃NH₃PbI₃ in dimethylformamide.

The magnetic-photoconductive composition, or the layered structure LS forms a magnetic-photoconductive element 1.

Another aspect of the present invention concerns the magneto-optical information storage device 3 (FIG. 2) including or consisting of the magnetic-photoconductive element that comprises or consists of the magnetic-photoconductive composition 1, or the layered structure LS.

A further aspect of the present invention concerns the magneto-optical information storage apparatus or system 5 in which information is stored in the magnetic-photoconductive material 1 of magneto-optical storage device 3. The system 5 includes, for example, a light source 9 such as a laser or LED, and a read/write head or device 11 configured applying a magnetic field to the magnetic-photoconductive material 1 to register information in the magnetic-photoconductive material 1 and/or to read information registered the material 1. The system 5 may further include optical guiding means, such as an optical waveguide or lens, to guide the emitted light beam to the magneto-optical storage device 3 or material 1. The light source 9 can be an integrated light source integrated to the read/write head or device 11.

Another aspect of the present invention relates to a method for operating the system 5. The method includes illuminating a zone of the magnetic-photoconductive material 1 of the storage device 3 with a light beam to generate photo-carriers to place the storage zone of the storage device 3 in a state to be configured or reconfigured without changing the temperature of said storage zone. An external magnetic field is applied in order to induce a magnetization direction in the storage zone and encode information in the storage zone. While simultaneously maintaining the applied magnetic field, illumination is removed from the storage device zone to remove the photo-carriers and to register the induced magnetization direction in the storage zone. The magnetization direction follows a direction parallel to the write-field of the applied external magnetic field.

The magneto-optical information storage device 3 thus includes optically assisted magnetic writing and magnetic readout.

The magneto-optical (MO) photoconducting-ferromagnetic (PC-FM) storage device 3, for example CH₃NH₃(Mn:Pb)I₃ (for example CH₃NH₃(Mn₁₀:Pb₉₀)I₃) is provided on a substrate 7 (FIG. 2).

The PC-FM storage device 3 is illuminated by a low-power light beam of the optical source 9, typically in the range 1 nWcm⁻² to 200 nWcm⁻², preferably 20 nWcm⁻². An area or volume of the material 1, in which registration is to occur, is illuminated.

As a result conduction electrons generated in material 1 and the magnetic order of the MO media 1 is melted (put in a state to be configured or reconfigured) without changing its temperature. That is, during the registration of a magnetization direction, the applied optical power generates no temperature change in the photoconducting-ferromagnetic (PC-FM) material 1. The only possible temperature change that occurs in the material 1 may be due to a fluctuation in the ambient temperature. The application of the optical energy permits a temperature-change free registration or recording of a magnetization direction as previously mentioned above in relation to the material 1.

The magnetic-photoconductive material 1 permits the state change or the registration or recording of a magnetization direction in the material 1 at a material temperature less than the Curie Temperature (T_{C}) or Curie point. The incident optical power on an area or volume of the magnetic-photoconductive material 1 does not increase the material temperature above the Curie Temperature (T_{C}) or Curie point.

At this moment (under illumination) an external magnetic field, applied by head 11, is switched on in order to encode the information in the magnetization direction to be written. The incident light is switched off and the photocarriers disappear inside the material 1. Accordingly the magnetization of the concerned area or volume of the MO storage material 1 is registered or recovered with a direction parallel to the write-field. Advantageously, the achievable switching time is in the 1 to 10 ns range required for relaxation of photo-excitations.

Another aspect of the present invention relates to light-tunable microwave components.

The magnetic and photoconductive material 1 permits to controllably vary the magnetic permeability (μ) and dielectric permittivity (ε) by light illumination and the generation of photo-carriers.

FIG. 3 shows a stripline microwave transmission line 15a including the photoconducting (PC) ferromagnetic (FM) dielectric or material 1. The outer and inner conductors 17 of the stripline are shown where the inner conductor is enclosed in the PC-FM material 1. An external light source 19 is included to control the dielectric properties of the PF-FM dielectric or material 1.

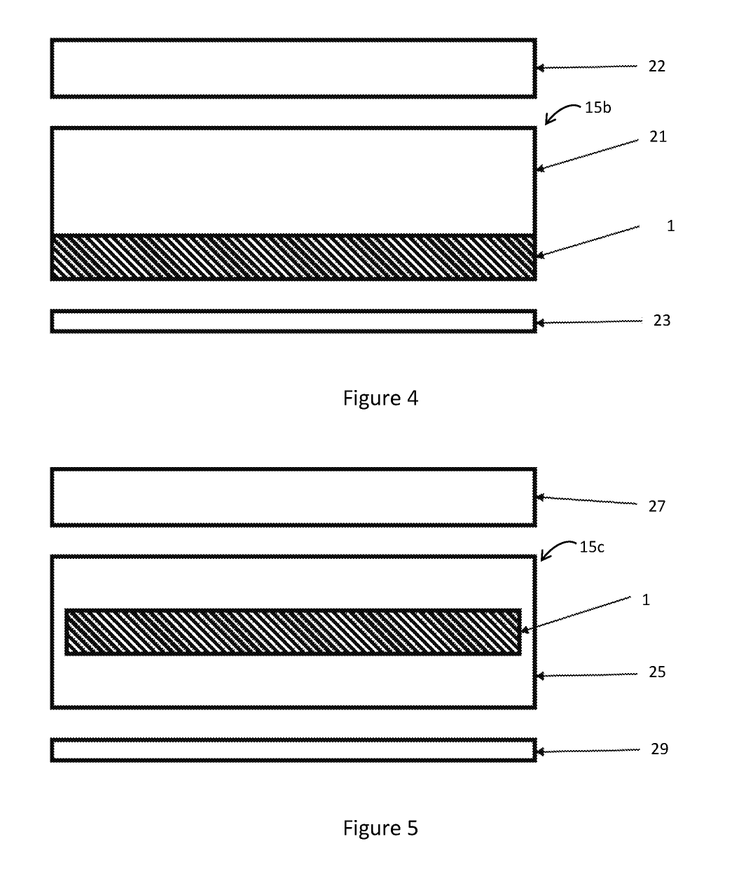

FIG. 4 shows a microwave isolator 15b. The microwave isolator 15b includes a waveguide 21 that comprises and is asymmetrically filled by the PC-FM dielectric or material 1. A bias magnetic field is provided by an external magnet 22. An external light source 23 is used to control the properties of the PF-FM dielectric or material 1.

FIG. 5 shows a microwave attenuator or phase shifter 15c including a waveguide 25 that is symmetrically filled by the PC-FM dielectric or material 1. A biasing magnetic field is provided by an external magnet 27. A light source 29 is provided to control the dielectric properties of the PF-FM dielectric or material 1.

The light-tunable microwave components 15a, 15b, 15c take advantage of the continuous tunability of the conductivity and thus dielectric constant of the PC-FM material 1 by changing the light intensity incident on the material 1. Light induced photo carriers also change the magnetic permeability (μ) and the ferromagnetic resonance frequency of the FM material. The achievable switching time is in the 1-10 ns range limited by the relaxation of photo-excitations.

The magnetic permeability (μ) and dielectric permittivity (ε) of the material 1 can be controllably varied by light illumination to maintain constant characteristic impedance and electrical length of the components 15a, 15b, 15c regardless of the frequency at which the component is tuned and to set the ferromagnetic resonance frequency to a desired value by light illumination.

The tunable microwave component 15a, 15b, 15c can have a constant characteristic impedance at the first and second frequencies. The tunable microwave components 15a, 15b, 15c can have a constant electrical length at the first and second frequencies.

In a method for operating the tunable microwave component 15a, 15b, 15c the magnetic-photoconductive material 1 can be illuminated with a light intensity to generate a photo-current intensity to modify a magnetic permeability (μ) of the magnetic-photoconductive material 1 to tune the operating frequency of the tunable microwave component to a first operating frequency.

The magnetic-photoconductive material 1 of the tunable microwave component can be illuminated with a different light intensity to generate a different photo-current intensity to modify the magnetic permeability (μ) of the magnetic-photoconductive material 1 of the tunable microwave component to tune the operating frequency of the tunable microwave component to a second operating frequency. Because material 1 possesses the advantage of high switching speeds, and low power consumption, microwave devices 15a, 15b, 15c provide for higher speed lower operation cost microwave systems.

The tunable microwave component 15a, 15b, 15c may include the photo-conductive composition 1 or the layered structure LS. In the case of the layered structure LS, the photoconductive PC layer generates a photocurrent when light from a light source is applied to the at least one photoconductive (PC) material, and magnetic or ferromagnetic FM layer changes magnetic permeability with the generated photocurrent to tune the microwave component from a first frequency when the component is in a non-illuminated state in which a light source applies no light, to a second frequency when the component is in an illuminated state in which a light source applies light to the photoconductive (PC) layer.

Magnetic materials are the corner stone of today's information technology. The most widespread examples are hard disks and magnetoresistive random access memories. The demand for ever-increasing density of information storage and speed of manipulation has launched an intense search for controlling the magnetization of a medium by means other than magnetic fields. Recent experiments on laser-induced manipulation of magnetic order triggered great interest. However, in all these cases either the substances were heated by the absorbed laser power close to the ordering temperature or a highly non-equilibrium state was prepared for femtosecond time intervals of a laser pulse where the magnetic domain could be altered.

A fundamentally different approach is followed for optical manipulation of magnetism according to the present invention. Advantage is taken of the photo-excited conduction electrons in a (ferro)magnetic photovoltaic perovskite, for example, CH₃NH₃(Mn:Pb)I₃ to directly modify the local magnetic interactions and to melt the magnetic order during the illumination. This provides an alternative and very simple and efficient way of optical spin control, and opens a new avenue for applications of low power light as tuning parameter in magnetic devices.

The mechanism of magnetic interactions and eventually the magnetic order in insulating and conducting materials are fundamentally different. Diluted localized magnetic (M) ions in insulating materials commonly interact over extended distances by the strong super-exchange (SE) interaction via atomic orbital bridges through nonmagnetic atoms, e.g. oxygen, O. Common schemes for interactions in perovskite structures are the M-O-M, or M-O-O-M-like bridges. The strength and sign (anti- or ferromagnetic, AFM/FM) of these interactions are determined by the geometry of the bonds. Thus, the in situ fine-tuning of the interactions is usually difficult because it would call for structural alterations. A limited continuous change is possible by application of pressure. Discrete changes in the lattice are achieved by chemical modifications like replacing the bridging element with halides creating M-Cl-M, M-Br-M or M-I-M bonds.

Long-range magnetic interaction of M ions in a conducting host in addition to SE is usually mediated by the double-exchange (DE) or the RKKY interactions. In the RKKY interaction the density of the localized moments and the density of itinerant electrons are the key control parameters. The RKKY coupling strength oscillates between AFM or FM as a function of the M-M distance and of the radius of the Fermi surface. These parameters, however, similarly to the case of the SE, are intrinsic to the studied system and in situ modifications are not feasible.

Technologically relevant materials emerge when the magnetic interactions of localized and itinerant spins compete and give an extremely large change, for instance, in resistivity as a result of small external perturbations. A well-known example is (La:Sr)MnO₃ perovskite where ferromagnetic DE interactions mediated by chemically doped electrons compete with the antiferromagnetic SE interaction of the parent insulating compound. This competition induces a metal-insulator transition and a ferromagnetic order for fine-tuned chemical compositions. Electronic control of this magnetic transition was demonstrated by electrolyte-gating. However, its mechanism, whether it is due to high field-induced carrier doping or due to electrochemical reduction is still unclear.

The present invention relates to a very elegant way of modulation of the magnetic order by using visible light illumination in, for example, the magnetic photovoltaic perovskite CH₃NH₃(Mn:Pb)I₃. By virtue of photodoping, one modifies the magnetic interactions thus inducing changes in the magnetic order.

This approach presents indisputable advantages over chemical doping since it is continuously tuneable by light intensity, spatially addressable by moving the illuminating spot and, last but not least, provides a fast switching time (in the ns range required for relaxation of photo-excitations). The exemplary organometallic perovskite CH₃NH₃PbI₃ (hereafter MAPbI₃) is used as to demonstrate the advantages of the present invention. Taking advantage of its chemical flexibility we have, for example, substituted in the pristine material 10% of Pb²⁺ ions with Mn²⁺ ions, which have resulted in a magnetic photovoltaic perovskite CH₃NH₃(Mn:Pb)I₃, (hereafter MAMn:PbI₃), (see FIG. 6). This material provides a unique combination of ferromagnetism (T_{C}=25 K) and high efficiency of photoelectron generation. It turns out that these two properties are intimately coupled in this material, thus optical control of magnetism is achieved.

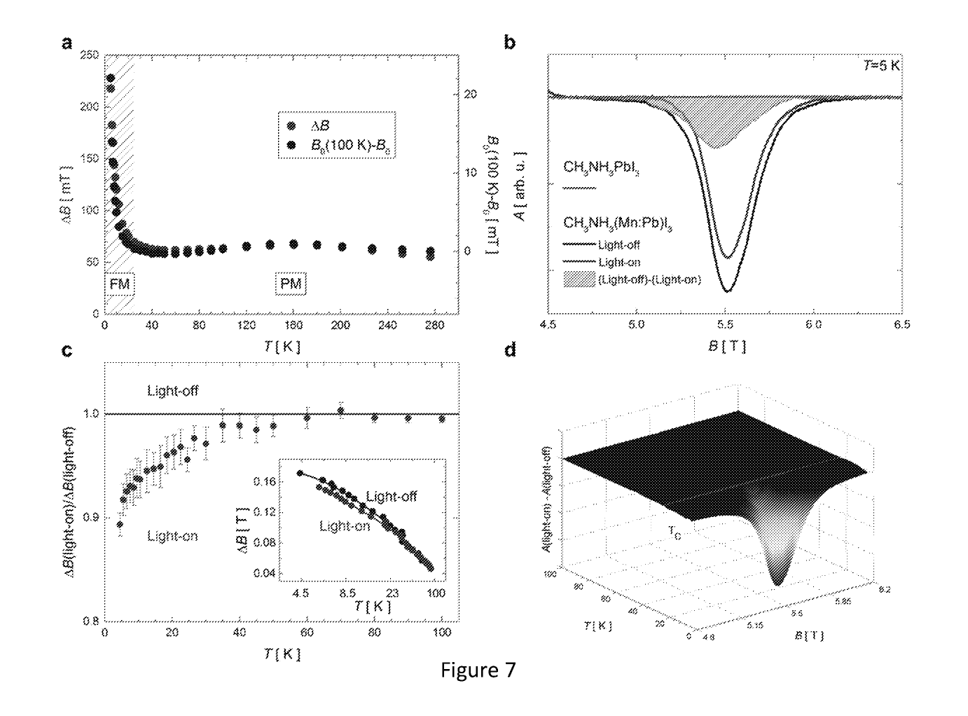

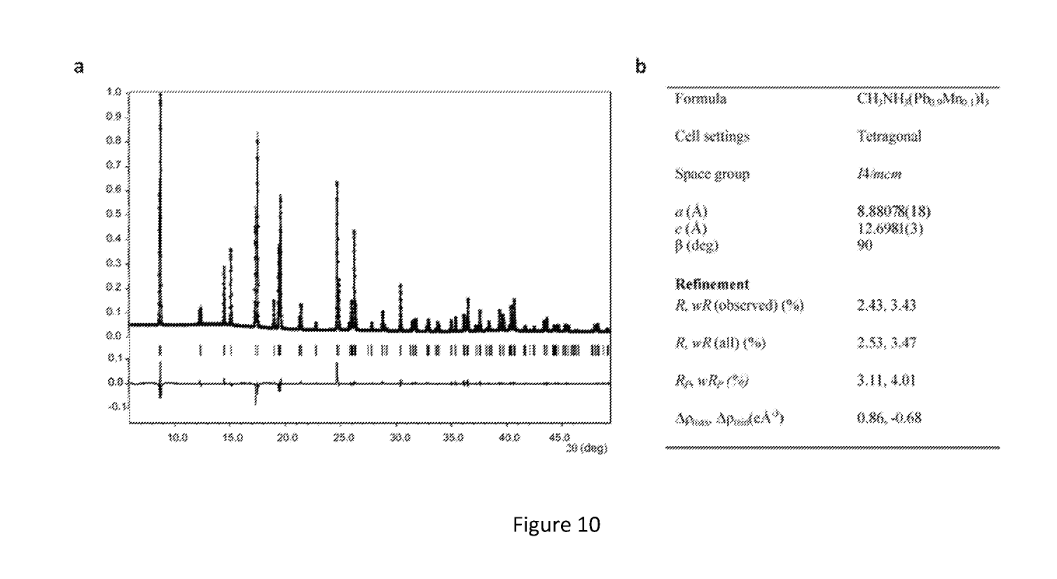

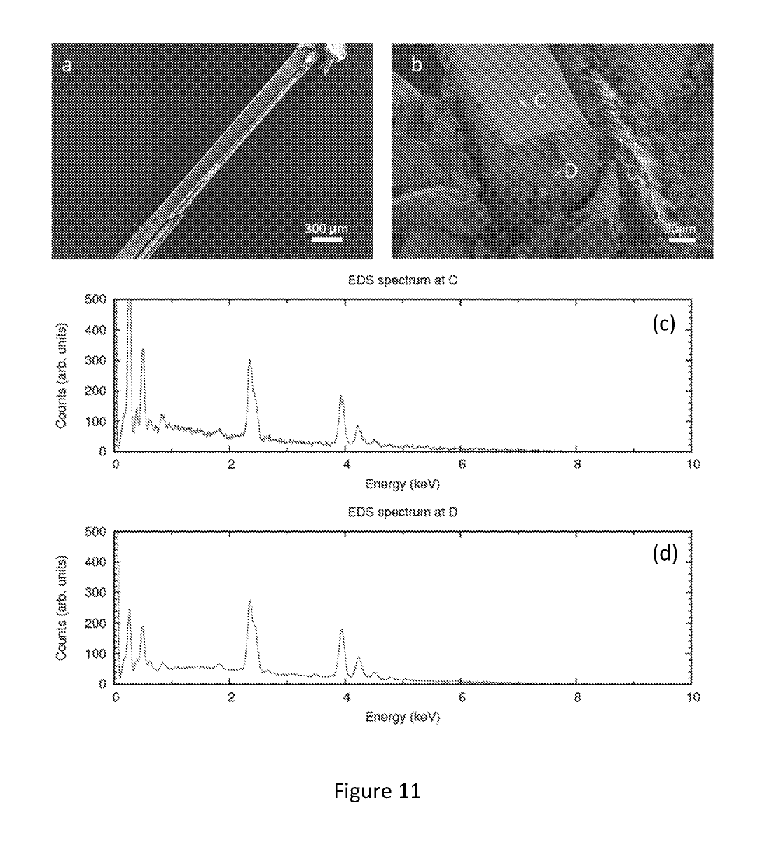

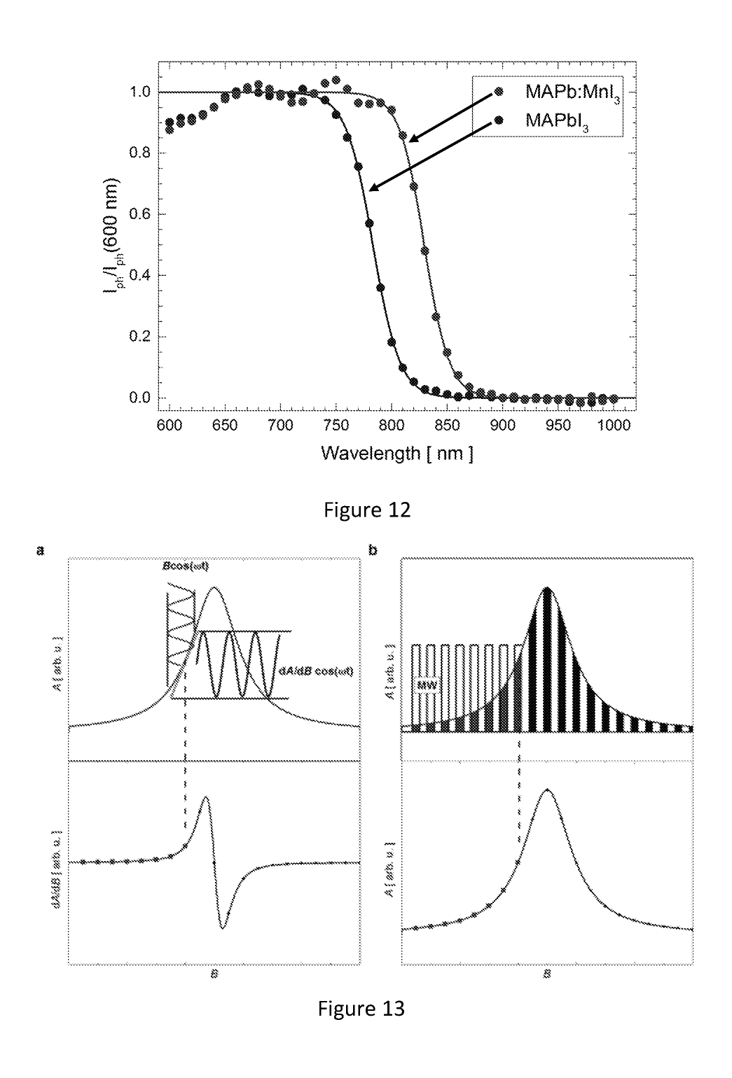

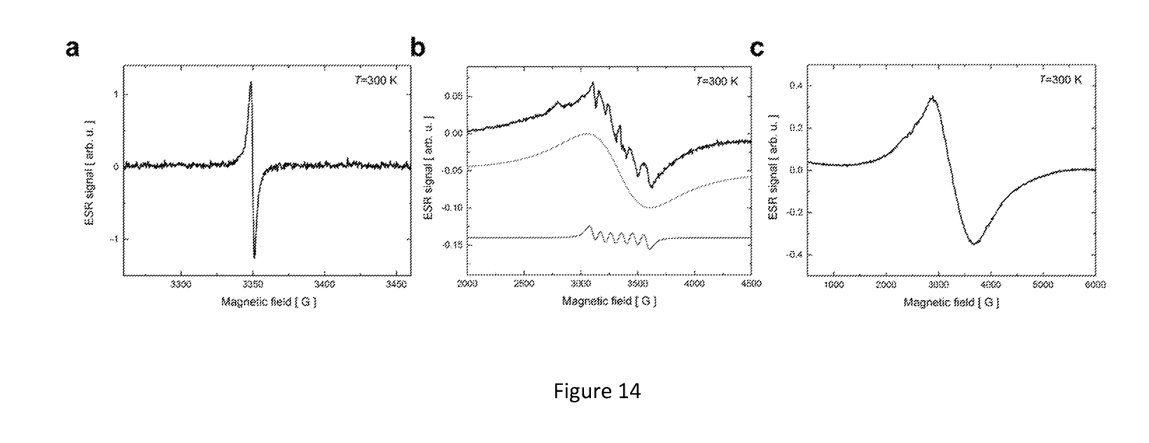

The substitution of Mn²⁺ ions into the MAPbI₃ perovskite network, in the above example, is revealed by synchrotron powder X-ray diffraction and energy dispersive X-ray measurements (see FIGS. 10 and 11 respectively). Mn²⁺ ions in the host lattice are isoelectronic with Pb²⁺. Hence, they do not dope the system as also confirmed by first-principles electronic structure calculations discussed below. The doped sample is semiconducting in dark with few MΩcm resistivity similarly to the parent compound. Moreover, the high level of Mn substitution does not diminish the photocurrent (Iₚₕ) generation. A strong Iₚₕ response is observed below 830 nm wavelength (FIG. 12) similarly to the case of the pristine material. The photocurrent and thus the carrier density can be fine-tuned by the incident light intensity in broad frequency and intensity ranges. The Mn substitution, however, dramatically modifies the magnetic properties of the system as seen by Electron Spin Resonance (ESR) measurements (FIG. 7). The pristine material is nonmagnetic, only ppm level of paramagnetic impurities could be detected. On the contrary, Mn substitution gives an easily observable signal. At low concentration ESR shows well resolved hyperfine lines indicating the uniform dispersion of Mn²⁺ ions²¹ (FIG. 14). The MAMn:PbI₃ sample shows a strong ESR signal (FIG. 7) and, most importantly, a ferromagnetic order developing below T_{C}=25 K upon cooling in dark. This is testified by the rapid shift of the resonant field, B₀, and the broadening of the line width, ΔB, below T_{C} (FIG. 7a) which are sensitive measures of the magnetic interactions and the internal magnetic fields. It should be emphasized that the magnetic ordering itself in this insulating photovoltaic perovskite is already a remarkable observation.

A major finding of the inventors is the striking change of the magnetism when the sample is exposed to light illumination with energy higher than the band gap, λ_{edge}=830 nm (FIG. 12). To avoid possible heating effects, we used λ=655 nm, 4 μW/cm² light illumination provided by a low-power LED light which is close to the maximal quantum efficiency of MAMn:PbI₃. Typical ESR absorption spectra taken by light-off and light-on at T=5 K are shown in FIG. 7b. The difference between light-on and light-off signals is shown. It corresponds to 25% of disappearance of the initial spin susceptibility (χ_{ESR}) upon light exposure.

The change is completely reversible. As χ_{ESR} is directly proportional to the ferromagnetic volume, the results demonstrate that in one fourth of the sample the ferromagnetic order is melted by light illumination. As shown in the following, it is an athermal, magnetic change induced by photo-excited conduction electrons in the insulating magnetic phase. The optical switching of the signal persists only up to T_{C} of the magnetically ordered phase as shown by all ESR observables B₀, ΔB and χ_{ESR} (FIGS. 7c and 7d) which excludes heating effect by the LED. The narrowing of ΔB in the remaining magnetic signal observed below T_{C} (FIG. 2c) is a consequence of the surface melting of the magnetic order, as it is not accompanied by change of B₀. The ferromagnetic ΔB is a strong function of sample shape and size. The light is absorbed in the first few microns of the crystals where the FM is molten so the created magnetic core-shell structure effectively changes the morphology of the sample, thus ΔB.

On the qualitative basis, one can interpret the light induced melting of the magnetic structure as the competition between the SE- and the light induced RKKY-interactions. SE orders the entire sample magnetically in dark. It is known that halide bridges can mediate the interaction between localized Mn²⁺ moments by SE in insulating perovskite crystals. Under illumination, one creates conduction electrons which alter the spin order established by SE as described by the RKKY Hamiltonian. Recent electrical transport measurements show that below 160 K even a metallic state could persist in a broad illumination intensity/photo-carrier density range.

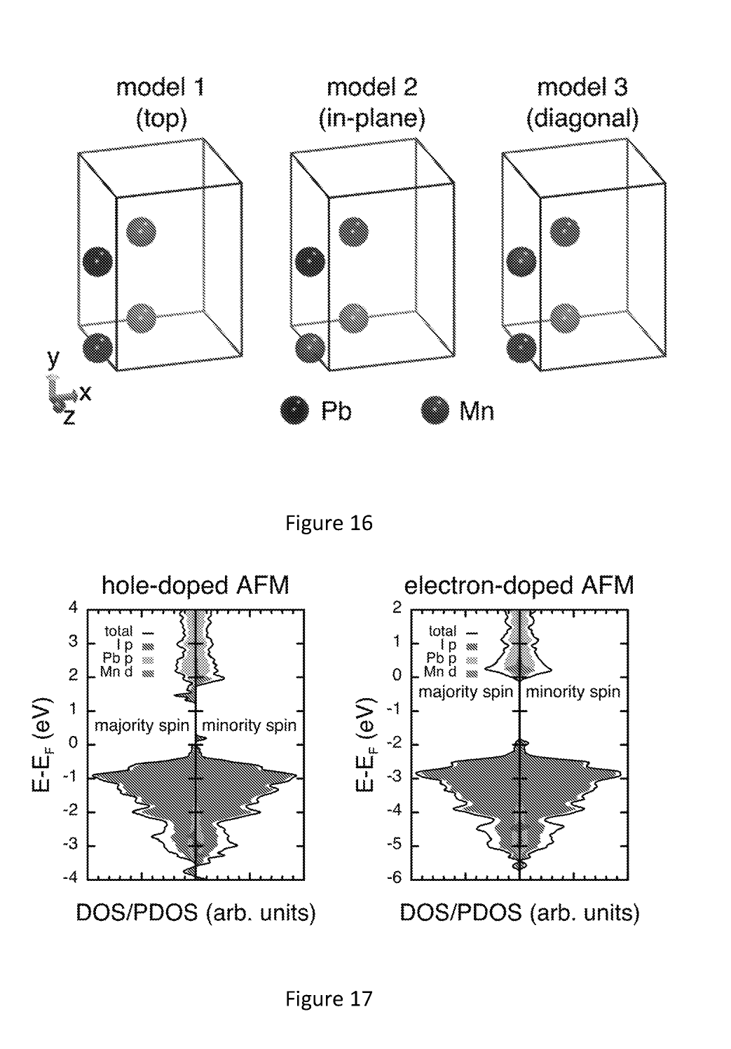

This scenario is further supported by more rigorous density functional theory (DFT) calculations. The model of MAMn:PbI₃ was constructed starting from the experimentally determined low-temperature orthorhombic (Pnma) crystal structure of undoped material, which was then extended to the 2×1×2 supercell. Two Pb atoms in the supercell were replaced by Mn atoms in order to allow investigating the exchange interactions between Mn dopants. Overall, one Pb atom of eight was substituted, which corresponds closely to the 10% doping concentration of experimentally investigated samples. Three different arrangements of Mn dopants were studied and are shown in FIG. 16.

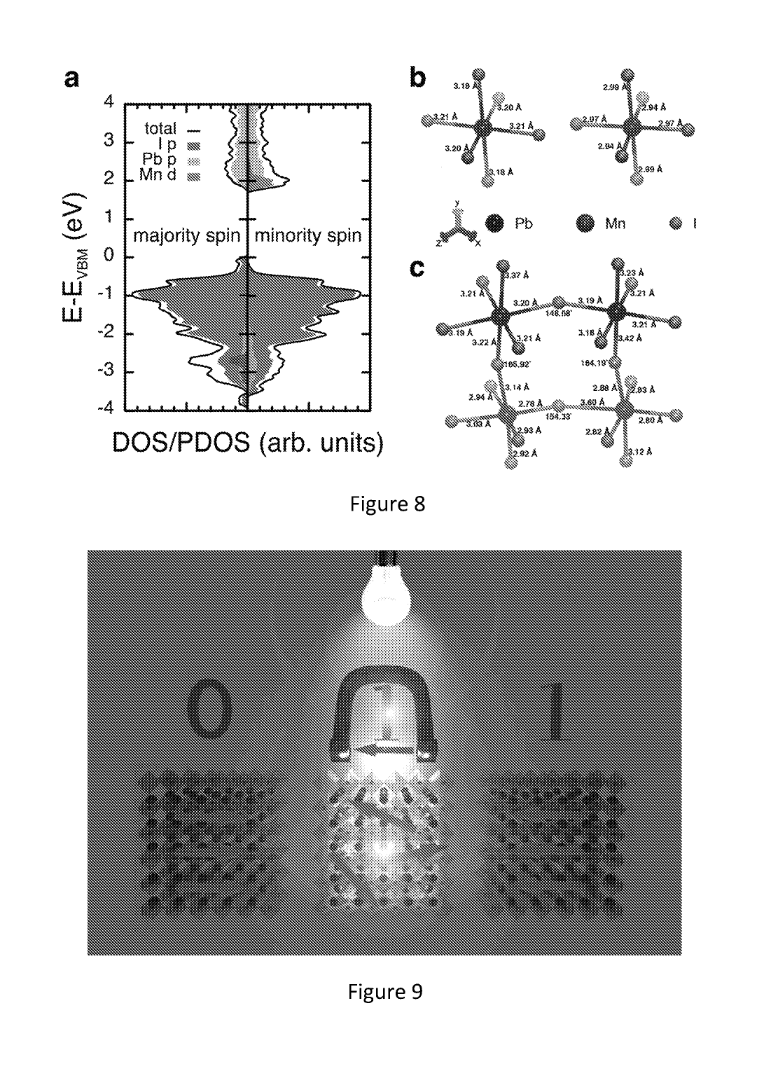

The energy differences between the FM and AFM configurations are of the order of 10-20 meV, while the interaction sign varies across the studied models. We found that for the “in-plane” model (model 2 in FIG. 16), the FM configuration is the ground state, which is 10.9 meV lower in energy compared to the AFM configuration. The density of states plot calculated for the charge-neutral configuration of “in-plane” model shows that Mn²⁺ impurities substituting Pb²⁺ ions do not give rise to charge-carrier doping and do not induce any mid-gap states (FIG. 8a). The FM interaction is the consequence of the strongly distorted orthorhombic perovskite structure with Mn—I—Mn bond angle significantly reduced to about 1500 (FIGS. 8(b) & (c)). The effect of photoexcited charge carriers was addressed by considering separately electron- and hole-doped models since excitons cannot be described by DFT. Upon doping the “in-plane” case, the ground state changes from FM to AFM with relative energies of 20.4 and 10.9 meV for one hole and for one electron per supercell, respectively.

The corresponding total and projected density of states plots for the doped models in their AFM state are shown in FIG. 17. These model calculations demonstrate the possibility of suppressing FM order in MAMn:PbI₃ by means of photo-excitations.

The measured maximum switching volume ratio of 25%, in fact, is only related to the problem of the bulk sample geometry and can be easily overcome in smaller structures, where such reorientation is of practical importance. For example, in a magnetic thin film of a hard drive, the light-induced magnetization melting will trigger, via a small magnetic guide field, a switching of the ferromagnetic moment into the opposite state. This possible application is illustrated in FIG. 9. The reversal of the ferromagnet requires only a small guide-field to overcompensate the stray field of neighbouring bits. This principle could be integrated in hard disk drives when the illumination is provided by a LED on the read/write head.

An exemplary ferromagnetic MAMn:PbI₃ has thus been prepared. It has been demonstrated that the high-efficiency photocurrent generation by low power visible light illumination results in a melting of the ferromagnetic state and a small local field can set the direction of the magnetic moment. It should be emphasized that this mechanism is radically different from switching the orientation of magnetic domains—here the photoelectrons tune the local interaction between magnetic moments. This allows for the development of a new generation of magneto-optical data storage devices where the advantages of magnetic storage (long-term stability, high data density, non-volatile operation and re-writability) can be combined by the fast operation of optical addressing. Thin films with higher T_{C} where the total melting of the magnetism in MAMn:PbI₃ can be achieved upon illumination are possible.

### Sample Preparation:

CH₃NH₃(Mn:Pb)I₃ (for example CH₃NH₃(Mn₁₀:Pb₉₀)I₃) single crystals were prepared by precipitation from a concentrated aqueous solution of hydriodic acid (57 w % in H₂O, 99.99% Sigma-Aldrich) containing lead (II) acetate trihydrate (99.999%, Acros Organics), manganese (II) acetate tetrahydrate (99.0%, Fluka) and a respective amount of CH₃NH₂ solution (40 w % in H₂O, Sigma-Aldrich). A constant 55-42° C. temperature gradient was applied to induce the saturation of the solute at the low temperature part of the solution (Reference 20). Besides the formation of hundreds of submillimeter-sized crystallites (polycrystalline powder) large aggregates of long MAMn:PbI₃ needle-like crystals with 5-20 mm length and 0.1 mm diameter were grown after 7 days (FIG. 6). Leaving the crystals in open air resulted in a silver-grey to green-yellow colour change. In order to prevent this unwanted reaction with moisture the as synthesized crystals were immediately transferred and kept in a desiccator prior the measurements. Millimetre size un-doped (CH₃NH₃PbI₃) single crystals were also synthesized and kept as a reference material for qualitative analysis.

Synchrotron X-ray powder diffraction (XRD) pattern of the CH₃NH₃(Mn:PbI)I₃ sample was measured at room temperature at the Swiss-Norwegian beam lines of the European Synchrotron Radiation Facility (ESRF). The wavelength of the used synchrotron radiation was 0.9538 Å. All data were collected in the Debye-Scherrer geometry with a Dectris Pilatus2M detector. The sample-to-detector distance and the detector parameters were calibrated using a LaB₆ NIST reference powder sample. The powders were placed into 10 μm glass capillaries and mounted on a goniometric spinning head. For Rietveld refinement Jana crystallographic program was used. Crystal structure was refined in I4/mcm tetragonal space group. Refined atomic parameters of Pb, I, C and N are very similar to those published for CH₃NH₃PbI₃³¹. In addition, H atoms were also localized. The XRD profile together with the results of the Rietveld profile fitting is shown in FIG. 10.

Scanning Electron Microscope images were taken with a MERLIN Zeiss electron microscope. Individual single needle-like crystallites were broken off from the rod like bundles of MAMn:PbI₃ for Scanning Electron Microscope micrographs (FIG. 11). Aluminium pucks were used for sample support. Conducting carbon tape served as electric contact between the sample and the support.

Energy-Dispersive X-Ray Spectroscopy (EDS).

The elemental composition of the MAMn:PbI₃ crystallites were analysed by EDS (accelerating voltage of 8 kV, working distance of 8.5 mm). Samples were mounted on Al pucks with carbon tape with electrical contact to the surface also formed by carbon tape. The measurement was performed with an X-MAX EDS detector mounted at a 35 degrees take-off angle with a SATW window. EDS spectra were obtained at a working distance of 8.5 mm with 8 keV accelerating voltage and a current held at 184 pA. 2048 channels were used for the acquisitions, corresponding to energy of 5 eV per channel. Spectra were acquired over 1573 seconds of live time with detector dead time averaging of 4% and a dwell time per pixel of 500 μs. Quantitative EDS analysis utilized Aztec software provided by Oxford Instrument Ltd.

In order to obtain information on the homogeneity of Mn substitution of the MAMn:PbI₃ crystals EDS were performed on several positions on the as-grown surface of the needle-like MAMn:PbI₃ crystallites. For the purpose of gathering bulk information as well EDS spectrum were taken also on broken-off surfaces. These experiments systematically yield (Mn_{0.1}Pb_{0.9})I₃ stoichiometry indicating homogeneous Mn substitution.

Electron Spin Resonance Spectroscopy (ESR).

Polycrystalline assembly of 10-15 rod like MAMn:PbI₃ samples with typical 1 mm×0.1 mm×0.1 mm are sealed in a quartz capillary. ESR at 9.4 GHz microwave frequency was performed on a Bruker X-band spectrometer. A conventional field modulation technique was employed with lock-in detection which results the first derivative of the ESR absorption spectra. Experiments in the mm-wave frequency range were performed on a home-built quasi-optical spectrometer operated at 105 and 157 GHz frequencies in 0-16 T field range (FIG. 6).

A red LED was placed underneath the sample as a light source. Magnetic field strength at the sample position was calibrated against a KC₆₀ standard sample. In contrast to the low-field ESR experiments, at millimetre-wave frequencies a microwave power chopping was combined with lock-in detection. This detection scheme results directly the ESR absorption signal instead of its first derivative. The working principles of the two methods are shown in FIG. 13.

FIG. 14 compares pristine MAPbI₃ with 1% and 10% substituted MAMn:PbI₃ at room temperature. Pristine MAPbI₃ crystals show no intrinsic ESR signal. Only low, ppm levels of paramagnetic impurity centres were observed (FIG. 7 and FIG. 14). In contrast, Mn substitution to MAMn:PbI₃ results in a strong ESR signal. The spectra at 1% Mn²⁺ concentration consist of two signals. One set of sextet lines and an about 50 mT broad line (FIG. 14). The sextet signal is characteristic of a hyperfine splitting of Mn with g=2.001(1) g-factor and Aᵢₛₒ=9.1 mT hyperfine coupling constant. This spectrum corresponds to both allowed (sextet) and forbidden (broad component) hyperfine transitions between the Zeeman sublevels. It is characteristic to Mn²⁺ ions in octahedral crystal fields. Since strong forbidden transitions are observed, Mn²⁺ ions do not occupy strictly cubic sites, as strictly cubic centers have zero probability of forbidden transitions, rather distorted octahedral sites. These ESR characteristics are in good agreement with both powder X-ray diffraction and DFT calculations showing distorted octahedral Mn coordination. The ESR spectra of MAMn:PbI₃ at high Mn²⁺ concentration (10%) consist of one broad ESR line only. This is a common resonance of both allowed and forbidden transitions. We explain the uniformity of the g-factor by strong exchange narrowed spin-orbit interaction dominated line width of the Mn²⁺ ions.

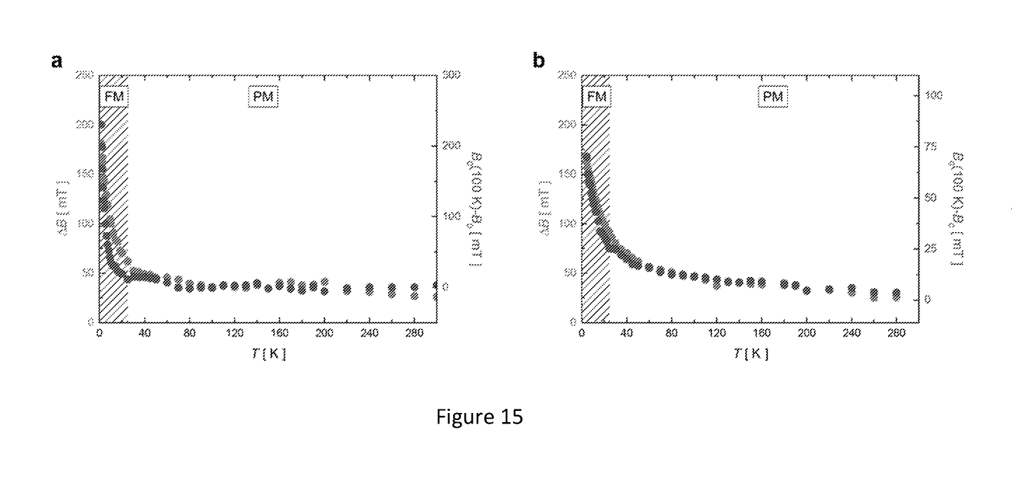

Calculations assuming a spin orbit width contribution of the order of (Δg/g)J, yield a value of the order of 100 K for exchange integral J. The broad ESR and isotropic g-factor is strongly intrinsic for the system. No evidence of frequency dependence at high temperatures in the 9-157 GHz frequency range is found. The field and temperature independent ΔB and B₀ is characteristic to exchange coupled paramagnetic insulators. Below 25 K both ΔB and B₀ acquires strong temperature dependence indicative of ferromagnetic ordering. The shift in B₀ measures the temperature dependence of the internal ferromagnetic field of MAMn:PbI₃. ΔB scales to B₀ at all measure fields and temperatures (see FIG. 8 and FIG. 15) indicating an inhomogeneous broadening induced by spatial distribution of the local internal ferromagnetic field. The inhomogeneity of the local internal ferromagnetic field is partially of geometrical origin. The demagnetizing field of our irregularly shaped particles is inhomogeneous. Additionally, the statistical fluctuations of the Mn concentration across the sample also increase the inhomogeneity by modulating the strength of the ferromagnetic order.

Photocurrent Spectroscopy.

For photocurrent spectra a low intensity monochromatic light was selected by a MicroHR grid monochromator from a halogen lamp. The wavelength resolution (FWFM) of the 600 gr/mm grating was 10 nm. The photo excited current was measured by a two-terminal method at fixed bias voltage of 1 V while the wavelength was stepwise changed (FIG. 12). Measurements were performed on pristine MAPbI₃ and Mn doped MAMn:PbI₃. The band gap energy was determined by fitting a Fermi-Dirac distribution to the data. The resulting gap energies are 783±1 nm and 829±1.4 nm for the MAPbI₃ and MAMn:PbI₃ respectively. The intrinsic width of the Fermi-Dirac distribution for both systems is thermally broadened. The strong, about 46 nm upshift of the band edge upon Mn substitution indicates that the substitution is homogeneous. It is also worth to mention that since the gap of MAMn:PbI₃ is reduced relative to MAPbI₃, Mn substitution presents an alternative route to extend the light absorption range, hence increase photocell efficiencies.

First-Principles Electronic Structure Calculations.

To corroborate the experimental findings, first-principles electronic structure calculations were carried out in the framework of density functional theory as implemented in the Quantum ESPRESSO package. The exchange-correlation energy is given by the Perdew-Burke-Emzerhof generalized gradient approximation while the electron-ion interactions are treated by using the ultrasoft pseudopotentials that have been published previously. Wave functions and charge densities are expanded using the plane-wave basis sets with kinetic energy cutoffs of 40 Ry and 320 Ry, respectively. The Brillouin zone (BZ) is sampled using 3×4×3 Monkhorst-Pack meshes of special k-points. The plane-wave cutoffs and k-point meshes are chosen to ensure the convergence of total energies within 10 meV. When performing calculations on charged models, a compensating jellium background was introduced in order to avoid the spurious divergence of electrostatic energy.

The models of Mn-doped CH₃NH₃PbI₃ were constructed starting from the experimentally determined crystal structure of undoped material (orthorhombic phase, space group Pnma), which was then extended to the 2×1×2 supercell by doubling the lattice constants along the a and c directions. Two Pb atoms in the supercell were replaced by Mn atoms in order to allow investigating the exchange interactions between Mn dopants. Overall, one Pb atom of eight was substituted, which corresponds closely to the doping concentration of experimentally investigated samples (10%). Three different arrangements of Mn dopants, referred to as “top”, “in-plane”, and “diagonal”, are shown in FIG. 16. Atomic coordinates of all these three configurations were optimized to the residual ionic forces smaller than 0.02 eV/Å, whereas the lattice parameters were kept fixed. For each configuration both the ferromagnetic (FM) and antiferromagnetic (AFM) arrangements of local magnetic moments of Mn atoms were investigated. Our calculations show that optimization of the internal atomic coordinates is crucial for reproducing the relative energies of FM and AFM configurations. Indeed, substitution of Mn atoms for Pb atoms lead to a pronounced lattice distortion around the Mn dopants due to different ionic sizes of Mn²⁺ and Pb²⁺. Specifically, the Mn—I distances are about 2.9 Å, whereas the Pb—I distances are about 3.2 Å (FIGS. 8(b) & (c)).

For all considered arrangements of Mn dopants, the energy differences between the FM and AFM configurations are of the order of 10-20 meV. We found that for model 2 (“in-plane”, FIG. 16), the FM configuration is the ground state, which is 10.9 meV lower in energy compared to the AFM configuration. Due to intrinsic limitations of density-functional-theory calculations, the effect of photoexcited charge carriers was addressed by considering separately electron- and hole-doped models. One has to emphasize that the DFT calculations correspond to a 0 K case and fixed number of photoelectrons. At finite temperatures and variable carrier density between the FM and AFM configurations it is reasonable to expect a paramagnetic state as seen in the experiment.

### REFERENCES

1 Kimel, A. V., Kirilyuk, A., Tsvetkov, A., Pisarev, R. V. & Rasing, T. Laser-induced ultrafast spin reorientation in the antiferromagnet TmFeO₃. Nature 429, 850-853 (2004).
2 Ohno, H. et al. Electric-field control of ferromagnetism. Nature 408, 944-946 (2000).
3 Lottermoser, T. et al. Magnetic phase control by an electric field. Nature 430, 541-544 (2004).
4 Kovalenko, O., Pezeril, T. & Temnov, V. New Concept for Magnetization Switching by Ultrafast Acoustic Pulses. Physical Review Letters 110, 266602 (2013).
Stanciu, C. et al. All-Optical Magnetic Recording with Circularly Polarized Light. Physical Review Letters 99, 047601 (2007).
6 Astakhov, G. et al. Nonthermal Photocoercivity Effect in a Low-Doped (Ga,Mn)As Ferromagnetic Semiconductor. Physical Review Letters 102, 187401 (2009).
7 Vahaplar, K. et al. Ultrafast Path for Optical Magnetization Reversal via a Strongly Nonequilibrium State. Physical Review Letters 103, 117201 (2009).
8 Hui, L., Bo, L., Huanyi, Y. & Tow-Chong, C. Thermally Induced Stability Issues of Head-Disk Interface in Heat-Assisted Magnetic Recording Systems. Japanese Journal of Applied Physics 44, 7950 (2005).
9 Khorsand, A. et al. Role of Magnetic Circular Dichroism in All-Optical Magnetic Recording. Physical Review Letters 108, 127205 (2012).
10 Zhang, G. P., Hubner, W., Lefkidis, G., Bai, Y. & George, T. F. Paradigm of the time-resolved magneto-optical Kerr effect for femtosecond magnetism. Nat Phys 5, 499-502 (2009).
11 Vahaplar, K. et al. All-optical magnetization reversal by circularly polarized laser pulses: Experiment and multiscale modeling. Physical Review B 85, 104402 (2012).
12 Hwang, H., Palstra, T., Cheong, S. & Batlogg, B. Pressure effects on the magnetoresistance in doped manganese perovskites. Physical Review B 52, 15046-15049 (1995).
13 Snively, L. O., Tuthill, G. F. & Drumheller, J. E. Measurement and calculation of the superexchange interaction through the two-halide bridge in the eclipsed layered compounds [NH₃(CH₂)ₙNH₃]CuX for n=2-5 and X=Cl₄ and Cl₂Br₂. Physical Review B 24, 5349-5355 (1981).
14 Moritomo, Y., Asamitsu, A., Kuwahara, H. & Tokura, Y. Giant magnetoresistance of manganese oxides with a layered perovskite structure. Nature 380, 141-144 (1996).
15 Dhoot, A. S., Israel, C., Moya, X., Mathur, N. D. & Friend, R. H. Large Electric Field Effect in Electrolyte-Gated Manganites. Physical Review Letters 102, 136402 (2009).
16 Cui, B. et al. Reversible Ferromagnetic Phase Transition in Electrode-Gated Manganites. Advanced Functional Materials 24, 7233-7240, doi: 10.1002/adfm.201402007 (2014).
17 Stranks, S. D. et al. Electron-Hole Diffusion Lengths Exceeding 1 Micrometer in an Organometal Trihalide Perovskite Absorber. Science 342, 341-344, doi:10.1126/science.1243982 (2013).
18 Xing, G. et al. Long-Range Balanced Electron- and Hole-Transport Lengths in Organic-Inorganic CH₃NH₃PbI₃. Science 342, 344-347, doi: 10.1126/science.1243167 (2013).
19 Lee, M. M., Teuscher, J., Miyasaka, T., Murakami, T. N. & Snaith, H. J. Efficient Hybrid Solar Cells Based on Meso-Superstructured Organometal Halide Perovskites. Science 338, 643-647, doi: 10.1126/science.1228604 (2012).
20 Horváth, E. et al. Nanowires of Methylammonium Lead Iodide (CH₃NH₃PbI₃) Prepared by Low Temperature Solution-Mediated Crystallization. Nano Letters 14, 6761-6766, doi: 10.1021/n15020684 (2014).
21 Szirmai, P. et al. Synthesis of Homogeneous Manganese-Doped Titanium Oxide Nanotubes from Titanate Precursors. The Journal of Physical Chemistry C 117, 697-702, doi:10.1021/jp3104722 (2012).
22 Vonsovskii, S. V. Ferromagnetic resonance; the phenomenon of resonant absorption of a high-frequency magnetic field in ferromagnetic substances. (Pergamon Press, 1966).
23 Coey, J. M. D., Venkatesan, M. & Fitzgerald, C. B. Donor impurity band exchange in dilute ferromagnetic oxides. Nat Mater 4, 173-179 (2005).
24 MacDonald, A., Schiffer, P. & Samarth, N. Ferromagnetic semiconductors: moving beyond (Ga, Mn) As. Nature Materials 4, 195-202 (2005).
Dietl, T. A ten-year perspective on dilute magnetic semiconductors and oxides. Nat Mater 9, 965-974 (2010).
26 Kolley, E., Kolley, W. & Tietz, R. Ruderman-Kittel-Kasuya-Yosida interaction versus superexchange in a plane in the limit. Journal of Physics: Condensed Matter 10, 657 (1998).
27 Keffer, F. & Oguchi, T. Theory of Superexchange. Physical Review 115, 1428-1434 (1959).
28 Van Vleck, J. H. Note on the Interactions between the Spins of Magnetic Ions or Nuclei in Metals. Reviews of Modern Physics 34, 681-686 (1962).
29 Pisoni, A. et al. Metallicity and conductivity crossover in white light illuminated CH₃NH₃PbI₃ perovskite submitted to Nature Physics (2014).
30 Baikie, T. et al. Synthesis and crystal chemistry of the hybrid perovskite (CH₃NH₃)PbI₃ for solid-state sensitised solar cell applications. Journal of Materials Chemistry A 1, 5628-5641, doi:10.1039/C3TA10518K (2013).
31 Kawamura, Y., Mashiyama, H. & Hasebe, K. Structural Study on Cubic-Tetragonal Transition of CH₃NH₃PbI₃. Journal of the Physical Society of Japan 71, 1694-1697, doi: 10. 1143/JPSJ.71.1694 (2002).
32 Nafridi, B., Gaal, R., Sienkiewicz, A., Feher, T. & Forró, L. Continuous-wave far-infrared ESR spectrometer for high-pressure measurements. Journal of Magnetic Resonance 195, 206-210, doi: http://dx.doi.org/10.1016/j.jmr.2008.09.014 (2008).
33 Náfrádi, B., Gaál, R., Feher, T. & Forro, L. Microwave frequency modulation in continuous-wave far-infrared ESR utilizing a quasi-optical reflection bridge. Journal of Magnetic Resonance 192, 265-268, doi: http://dx.doi.org/10.1016/j.jmr.2008.03.004 (2008).
34 Monod, P. et al. Paramagnetic and antiferromagnetic resonance of CuO. Journal of Magnetism and Magnetic Materials 177-181, Part 1, 739-740, doi: http://dx.doi.org/10.1016/S0304-8853(97)00713-0 (1998).
35 Hohenberg, P. & Kohn, W. Inhomogeneous Electron Gas. Physical Review 136, B864-B871 (1964).
36 Kohn, W. & Sham, L. Self-Consistent Equations Including Exchange and Correlation Effects. Physical Review 140, A1133-A1138 (1965).
37 Giannozzi, P. et al. QUANTUM ESPRESSO: a modular and open-source software project for quantum simulations of materials. Journal of Physics: Condensed Matter 21, 395502 (2009).
38 Perdew, J., Burke, K. & Ernzerhof, M. Generalized Gradient Approximation Made Simple. Physical Review Letters 77, 3865-3868 (1996).
39 Vanderbilt, D. Soft self-consistent pseudopotentials in a generalized eigenvalue formalism. Physical Review B 41, 7892-7895 (1990).
40 Garrity, K. F., Bennett, J. W., Rabe, K. M. & Vanderbilt, D. Pseudopotentials for high-throughput DFT calculations. Computational Materials Science 81, 446-452, doi: http://dx.doi.org/10.1016/j.commatsci.2013.08.053 (2014).
41 Garrity, K. F., Bennett, J. W., Rabe, K. M. & Vanderbilt, D. GBR Vhigh-throughput pseudopotentials, <http://www.physics.rutgers.edu/gbrv/>(2014).
42 Monkhorst, H. & Pack, J. Special points for Brillouin-zone integrations. Physical Review B 13, 5188-5192 (1976).
43 Leslie, M. & Gillan, N. J. The energy and elastic dipole tensor of defects in ionic crystals calculated by the supercell method. Journal ofPhysics C: Solid State Physics 18, 973 (1985).

Having described now the preferred embodiments of this invention, it will be apparent to one of skill in the art that other embodiments incorporating its concept may be used. This invention should not be limited to the disclosed embodiments, but rather should be limited only by the scope of the appended claims.

While the invention has been disclosed with reference to certain preferred embodiments, numerous modifications, alterations, and changes to the described embodiments, and equivalents thereof, are possible without departing from the sphere and scope of the invention. Accordingly, it is intended that the invention not be limited to the described embodiments, and be given the broadest reasonable interpretation in accordance with the language of the appended claims.

What is c aimed is:

1. Magnetic-photoconductive material comprising:
(a) a magnetic photoconductive composition including a perovskite structure of the formula ABC₃,
wherein A is a first cation selected from any one or any combination of the following:
Li, Na, K, Rb, Cs, NH₄, NCl₄, PH₄, PF₄, AsH₃, CH₃PH₃, CH₃AsH₃, CH₃SbH₃, CH₃NH₃,
wherein B is a second cation selected from any one or any combination of the following divalent elements:
Mn, Co, Cr, Fe, Cu, Ni, rare earths; or
B is a cationic composition of the general formula DₓE_{y}F_{z}, where D=Pb²⁺, F=Sn²⁺ and E is selected from any one or any combination of the following divalent elements: Mn, Co, Cr, Fe, Cu, Ni, and rare earths; and wherein x, y and z are a weight percent and y≥0.08, 0≤x≤0.92 and 0≤z≤0.92 where y+y+z=1; and
wherein C is an anion selected from any one or any combination of the following:
halogens F, Cl, Br, I, At;
or
(b) a layered structure including at least one photoconductive layer and at least one magnetic layer;
the at least one photoconductive layer including a perovskite structure of the formula ABC₃,
wherein A is a first cation selected from any one or any combination of the following:
Li, Na, K, Rb, Cs, NH₄, NCl₄, PH₄, PF₄, AsH₃, CH₃PH₃, CH₃AsH₃, CH₃SbH₃, CH₃NH₃,
wherein B is a second cation selected from any one or any combination of the following divalent elements:
Pb, Sn, Mn, Co, Cr, Fe, Cu, Ni, rare earths,
wherein C is an anion selected from any one or any combination of the following:
halogens F, Cl, Br, I, At;
and wherein the at least one magnetic layer includes a perovskite structure of the formula ABC₃ wherein A is a first cation selected to be any one rare earth element or any combination of rare earth elements; or wherein A is a first cation selected to be (i) any one rare earth element or any combination of rare earth elements combined with (ii) any Group II element or elements or with (iii) any Group III element or elements;
wherein B is a second cation selected from any one or any combination of the following
divalent elements:
Mn, Ni, Cr, Fe; and
wherein C is oxygen.

2. A storage device including the magnetic-photoconductive material according to claim 1.

3. The system including the storage device as claimed in claim 2, the system further including a light source and a read-write head configured to apply a magnetic field.

4. The system including the storage device as claimed in claim 3, wherein the light source is an integrated light source located on the read-write head, and the integrated light source includes a light emitting diode or a laser, and a light beam is produced by the integrated light emitting diode or laser located on the read-write head.

5. The system as claimed in claim 3, the system further including optical guiding means wherein said light beam is guided by said optical guiding means to the magneto-optical storage device.

6.-8. (canceled)

9. A tunable microwave component comprising the magnetic-photoconductive material of claim 1.

10. The tunable microwave component of claim 9 comprising the magnetic-photoconductive material including the layered structure, wherein the at least one photoconductive layer generates a photocurrent when light from a light source is applied to the at least one photoconductive material, and
wherein the at least one magnetic layer changes magnetic permeability with the generated photocurrent to tune the microwave component from a first frequency when the component is in a non-illuminated state in which a light source applies no light, to at least a second frequency when the component is in an illuminated state in which a light source applies light to the at least one photoconductive layer.

11. The tunable microwave component of claim 9, wherein the tunable microwave component has a constant characteristic impedance at the first and second frequencies.

12. The tunable microwave component of claim 9, wherein the tunable microwave component has a constant electrical length at the first and second frequencies.

13. The tunable microwave component of claim 9, comprising the magnetic-photoconductive material including the magnetic photoconductive composition, wherein the composition has both photoconductive and ferromagnetic material properties.

14. The tunable microwave component of claim 9, wherein the at least one photoconductive layer and the at least one magnetic layer form thin films stacked to create a photoconductive layer/magnetic layer structure having both photoconductive and ferromagnetic material properties.

15. The tunable microwave component of claim 9, wherein the tunable microwave component is a microwave transmission line, or a microwave isolator, or a microwave attenuator, or microwave phase shifter.

16.-18. (canceled)

19. A tunable microwave component comprising:
at least one photoconductive material layer, wherein the at least one PC material generates a photocurrent when light from a light source is applied to the at least one PC material, and
at least one ferromagnetic material layer, wherein the at least one FM material changes magnetic permeability with the generated photocurrent to tune the microwave component from a first frequency when the component is in a non-illuminated state in which a light source applies no light, to at least a second frequency when the component is in an illuminated state in which a light source applies light to the at least one photoconductive material.

20. The tunable microwave component according to claim 19, wherein the at least one photoconductive layer includes a perovskite structure of the formula ABC₃,
wherein A is a first cation selected from any one or any combination of the following:
Li, Na, K, Rb, Cs, NH₄, NCl₄, PH₄, PF₄, AsH₃, CH₃PH₃, CH₃AsH₃, CH₃SbH₃, CH₃NH₃,
wherein B is a second cation selected from any one or any combination of the following divalent elements:
Pb, Sn, Mn, Co, Cr, Fe, Cu, Ni, rare earths;
wherein C is an anion selected from any one or any combination of the following:
halogens F, Cl, Br, 1, At;
and wherein the at least one ferromagnetic layer includes a perovskite structure of the formula ABC₃ wherein A is a first cation selected to be any one rare earth element or any combination of rare earth elements; or wherein A is a first cation selected to be (i) any one rare earth element or any combination of rare earth elements combined with (ii) any Group II element or elements or with (iii) any Group III element or elements;
wherein B is a second cation selected from any one or any combination of the following divalent elements:
Mn, Ni, Cr, Fe; and
wherein C is oxygen.

21. The tunable microwave component of previous claim 19, wherein the at least one photoconductive material layer and the at least one ferromagnetic material layer form thin films stacked to create a structure having both photoconductive and ferromagnetic material properties.

22.-25. (canceled)
